(19) United States
(12) Patent Application Publication
(10) Pub. No.: US 2008/0155810 A1
(43) Pub. Date: Jul. 3, 2008

(54) METHODS FOR FABRICATING A MAGNETIC SENSOR HEAD USING A CMP DEFINED HARD BIAS AND A TOTALLY FLAT READER GAP

(76) Inventors: Ying Hong, Morgan Hill, CA (US); Ming Jiang, San Jose, CA (US); Mustafa M. Pinarbasi, Morgan Hill, CA (US); John Westwood, San Jose, CA (US)

Correspondence Address: DUFT BORNSEN & FISHMAN, LLP, 1526 SPRUCE STREET, SUITE 302, BOULDER, CO, 80302, US

(21) Appl. No.: 11/616,717

(22) Filed: Dec. 27, 2006

(51) Int. Cl. G11B 5/127

(52) U.S. Cl. 29/603.18

(57) ABSTRACT

Methods for fabricating magnetic sensor heads using a CMP defined hard bias to fabricate a magnetic sensor head reader with a flat reader gap. The method comprises defining a read sensor of the magnetic sensor head. The method further comprises depositing an insulator layer on the read sensor. The method further comprises performing a chemical mechanical polishing (CMP) process down to a protective layer on the read sensor deposited while defining the read sensor to remove an overfill portion of the hard bias layer above the protective layer and to remove a sensor pattern masking layer above the protective layer.

### BACKGROUND OF THE INVENTION

1. Field of the Invention

The invention is related to the field of magnetic recording head fabrication, and in particular, to improved methods of fabricating a read sensor which involve using a chemical mechanical polishing (CMP) defined hard bias and totally flat reader gap.

2. Statement of the Problem

Magnetic disk drive systems typically include a magnetic disk, a magnetic recording head having read and write elements, a suspension arm, and an actuator arm. As the magnetic head is rotated, air adjacent to the disk surface moves with the disk. This allows the recording head (also referred to as a slider) to fly on an extremely thin cushion of air, generally referred to as an air bearing. When the recording head flies on the air bearing, the actuator arm swings the suspension arm to place the recording head over selected circular tracks on the rotating magnetic disk where signal fields are written to and read by the write and read elements, respectively. The write and read elements are connected to processing circuitry that operates according to a computer program to implement write and read functions.

The magnetic recording head read sensor is typically produced using thin-film deposition and patterning techniques. One process defines the stripe height of the read sensor, while another process defines the track width of the read sensor. In particular, the several material layers and processes which make up a read sensor for a magnetic recording head are typically formed by depositing full film sensor layers of the required materials on a wafer substrate, depositing and patterning a masking layer over the sensor layers to form a mask structure using a photolithographic process, etching the exposed portion of the sensor layers around the mask structure, and then removing the mask structure. In particular, the mask structure is removed using a chemical mechanical polishing (CMP) assisted lift-off process. Protective layers are deposited on the top of sensor layers and hard bias to protect the sensor layers during the CMP lift-off processes. These protective layers are then removed using any dry etching (e.g., reactive ion etching or ion milling) process.

This prior art process has reached its limitations and problems are encountered when fabricating magnetic sensor heads with narrow track widths such as 60 microns and below for high density magnetic recording heads. First, there may not be a sufficient amount of photo resistive material left above the read sensor for the CMP lift-off process to completely remove the mask structure. Second, fencing may occur around the read sensor once the protective and masking layers are removed. Third, large reader gap flare and shield curvature occurs due to the narrow track width and thick hard bias, which may reduce reader resolution (side reading) and stability (shield curvature).

It is evident from the above discussion that improved solutions are needed for fabricating magnetic sensor heads with narrow track width readers for high density magnetic recording heads.

### SUMMARY OF THE SOLUTION

The invention solves the above and other related problems with improved methods for fabricating a magnetic sensor head using a CMP defined hard bias and flat reader gap.

An exemplary embodiment comprises an improved method for fabricating magnetic sensor heads in which a CMP process is utilized (1) to perform mask lift-off on the top of a patterned read sensor with a narrow track width, (2) to define a hard bias and (3) to reach a flat reader gap. A second protective layer is not deposited above the hard bias layer. Rather, the hard bias layer is deposited on side regions of a read sensor of the magnetic sensor head structure at a height above the protective layer. The overfill hard bias is removed by CMP which stops at the protective layer to define the thickness of hard bias. The protective layer may then be optionally removed through an etching process to complete the fabrication process. Advantageously, this eliminates the problems described above during the magnetic sensor head fabrication process. Further, features and aspects herein allow for the use of rhodium (Rh) as a protective layer, which is not removed during the fabrication process. Rather, the rhodium layer may be used as part of a sensor cap of a read sensor of the magnetic sensor head to achieve a totally flat reader gap.

The invention may include other exemplary embodiments described below.

### DESCRIPTION OF THE DRAWINGS

The same reference number represents the same element or same type of element on all drawings.

FIG. 1 is a flow chart illustrating a prior art method for fabricating a magnetic sensor head, and in particular for defining the track width of a read sensor of the magnetic sensor head.

FIGS. 2-12 are cross-sectional views of a magnetic sensor head formed according to the method of FIG. 1.

FIG. 13 is a flow chart illustrating an exemplary method for fabricating a magnetic sensor head using a CMP defined hard bias and flat reader gap.

FIGS. 14-17 are cross-sectional views of a magnetic sensor head formed according to the method of FIG. 13.

FIG. 18 is a flow chart illustrating another exemplary method for fabricating a magnetic sensor head with a totally flat reader gap using a CMP defined hard bias.

FIG. 19 is a cross-sectional view of a magnetic sensor head formed according to the method of FIG. 18.

### DETAILED DESCRIPTION OF THE INVENTION

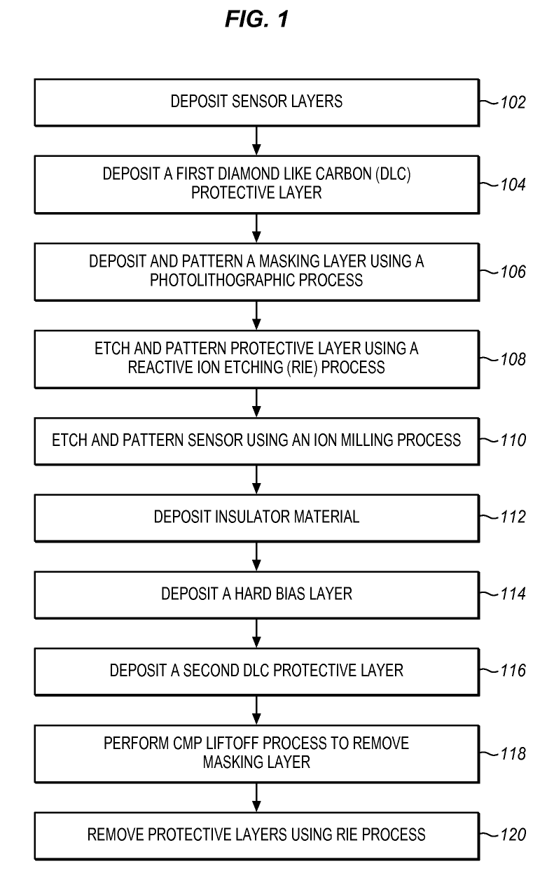

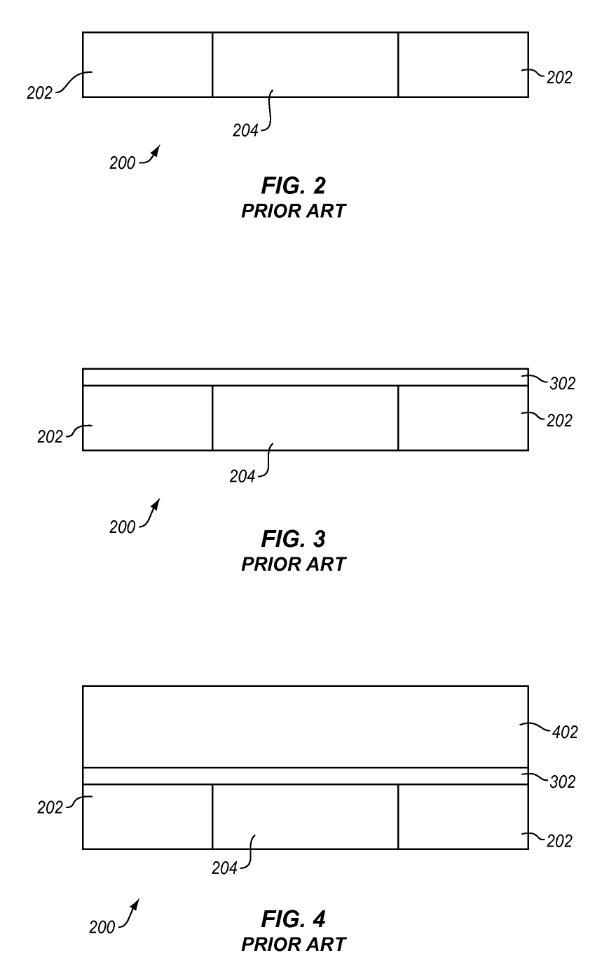

FIG. 1 is a flow chart illustrating a prior art process used for defining the track width of a read sensor of a magnetic sensor head. FIGS. 2-12 are schematic diagrams illustrating the layers of the magnetic sensor head during the track width fabrication process illustrated in FIG. 1.

In step 102 of FIG. 1, sensor layers 204 are deposited on a wafer (see FIG. 2). In prior art processes in which the stripe height is defined prior to the track width, the wafer may additionally comprise a stripe height under fill insulator layer 202 adjacent to the sensor layers 204. Sensor layers 204 and insulator layer 202 are typically deposited over a shield layer (not shown).

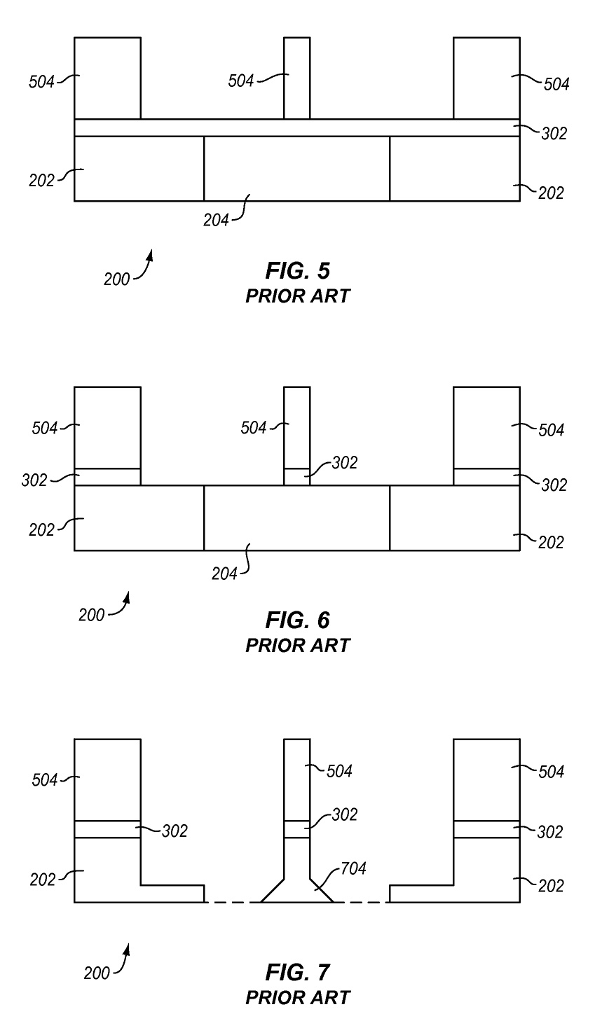

In step 104, a first protective layer 302 is deposited on the sensor layers 204 (see FIG. 3). In step 106, a masking layer 402 is deposited over the first protective layer 302 (see FIG. 4). Masking layer 402 is then patterned in a photolithographic process to form a mask structure 504 as illustrated in FIG. 5.

In step 108, the first protective layer 302 is etched using a reactive ion etching (RIE) process. Any exposed areas of the first protective layer 302 not protected by mask structure 504 are removed by exposure to the RIE process (see FIG. 6). In step 110, sensor layers 204 and insulator layer 202 are etched using an ion milling process to define read sensor 704 with desired dimensions as illustrated in FIG. 7.

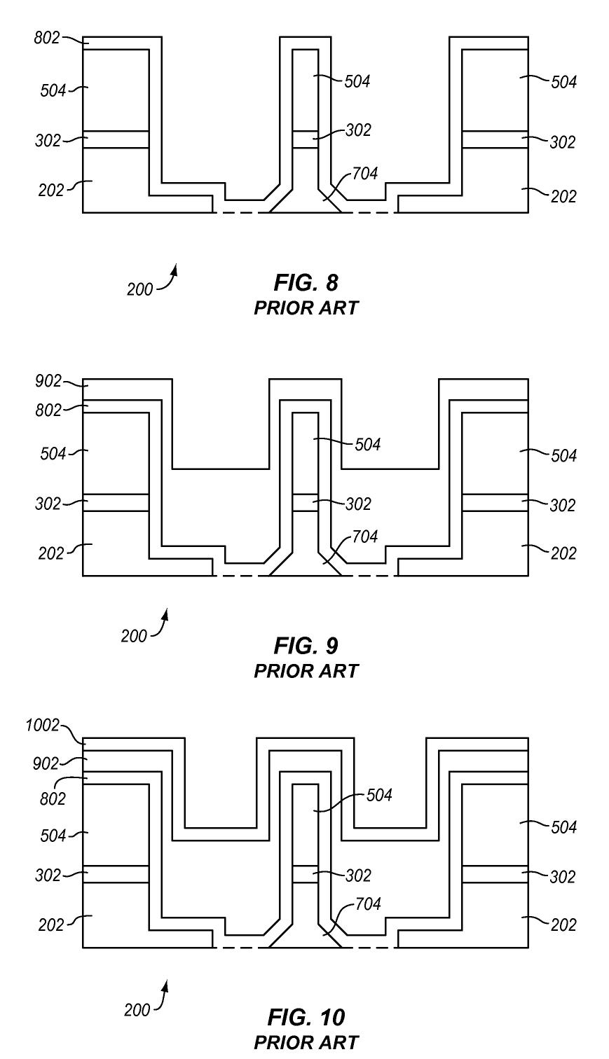

In step 112, an insulator layer 802 is deposited over read sensor 704, as illustrated in FIG. 8. In step 114, a hard bias layer 902 is deposited over insulator layer 802, as illustrated in FIG. 9. Additionally, a lead layer (not shown) may be fabricated over hard bias layer 902.

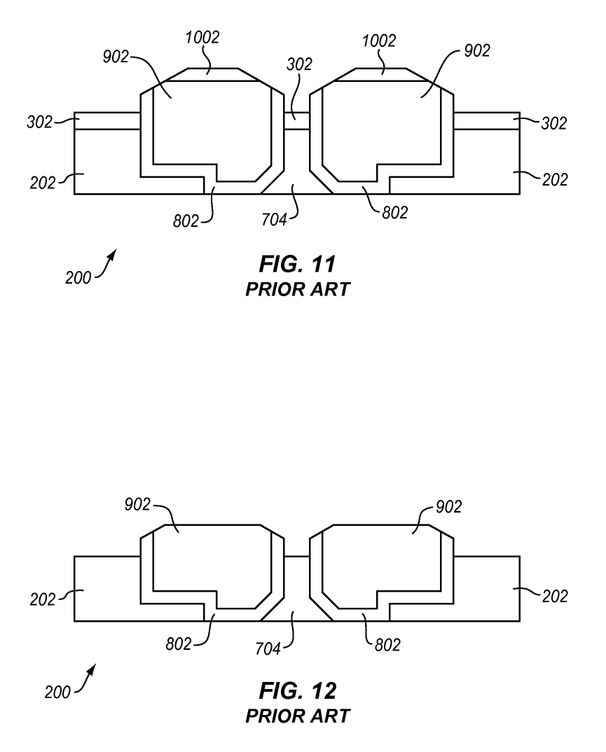

In step 116, a second protective layer 1002 is deposited over hard bias layer 902 as a stop layer for a CMP process (see FIG. 10). A CMP lift-off process is performed down to the stop layer. The CMP lift-off process removes mask structure 504 and material deposited above mask structure 504. Portions of insulator layer 802, hard bias layer 902 and second protective layer 1002 above mask structure 504 (e.g., above read sensor 704) are removed. The resulting structure is illustrated in FIG. 11.

In step 118, a second RIE process is used to remove first protective layer 302 and second protective layer 1002 as illustrated in FIG. 12.

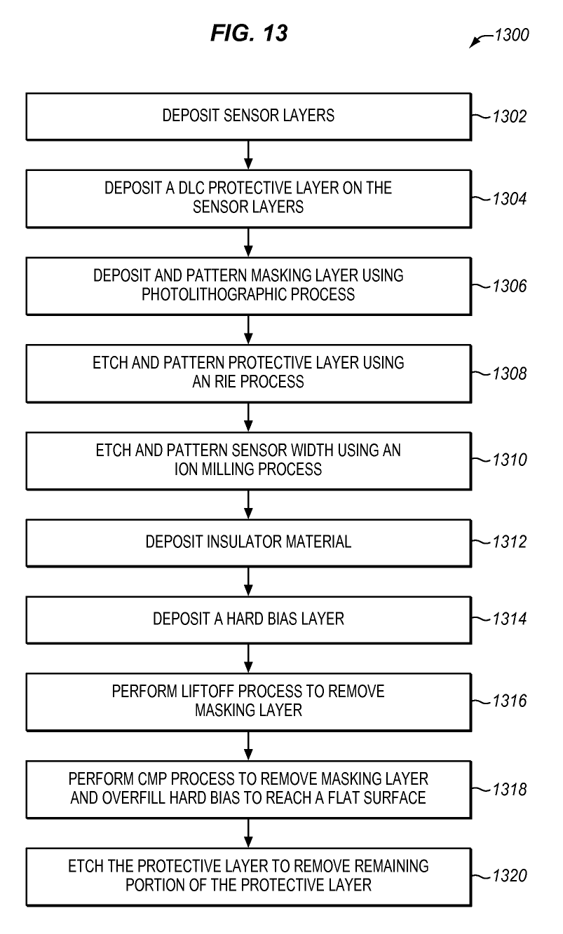

FIGS. 13-19 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 13 is a flow chart illustrating a method 1300 for fabricating magnetic sensor heads in an exemplary embodiment of the invention. The steps of the flow chart in FIG. 13 are not all inclusive and may include other steps not shown. Fabrication of magnetic sensor heads is commonly performed at the wafer level, and those skilled in the art understand that wafer level fabrication is assumed even if the description and drawings refer to a magnetic sensor head.

In step 1302, sensor layers 204 (see FIG. 2) for a magnetic sensor head 200 are deposited on a shield layer (not shown). The sensor layers 204 may be surrounded by insulating material 202. Insulating material 202 may be any suitable dielectric material, such as alumina (Al₂O₃) or SiO₂. The sensor layers 204 and insulating material 202 may be deposited during a stripe height definition process defining the stripe height of a read sensor of magnetic sensor head 200 prior to defining the track width of the read sensor. The resulting structure of magnetic sensor head 200 is illustrated in FIG. 2.

In step 1304, a protective layer 302 (see FIG. 3) is deposited on sensor layers 204. Protective layer 302 acts as a stop layer during a later CMP process. Protective layer 302 may be any suitable material, such as carbon. The carbon may be sputtered carbon or diamond-like carbon (DLC). The resulting structure of magnetic sensor head 200 is illustrated in FIG. 3.

In step 1306, a masking layer 402 of FIG. 4 is deposited on protective layer 302. Masking layer 402 is a photo resistive layer used to define the track width of a read sensor of magnetic sensor head 200. Masking layer 402 is etchable using reactive ion etching (RIE) for definition of a mask structure 504 (see FIG. 5).

To form mask structure 504, masking layer 402 is light exposed in a pattern to remove regions of masking layer 402 to create mask structure 504. If masking layer 402 is a positive photo resist, then masking layer 402 is light-exposed in regions to be removed. Otherwise, if masking layer 402 is a negative photo resist, then masking layer 402 is light-exposed in regions to be retained.

In step 1308, protective layer 302 is etched around mask structure 504 to remove a portion of protective layer 302 in end regions of sensor layers 204. If carbon is used as protective layer 302, then a reactive ion etching (RIE) process may be utilized to remove the end regions of protective layer 302. The RIE process may be performed using any suitable etch gas, such as one containing carbon-dioxide (CO₂) or oxygen (O₂). As shown by the resulting structure of magnetic sensor head 200 in FIG. 6, end regions of sensor layers 204 are thereby exposed as a result of the etching process in step 1308.

In step 1310, sensor layers 204 are etched to define a read sensor 704 of magnetic sensor head 200 (see FIG. 7). The defined read sensor 704 is produced by removing portions of sensor layers 204 through the etching process. The etching process may define the track width of read sensor 704. The etching process in step 1310 may be any suitable etching process, such as ion milling. Portions of insulating material 202 may also be removed. The resulting structure of magnetic sensor head 200 is illustrated in FIG. 7.

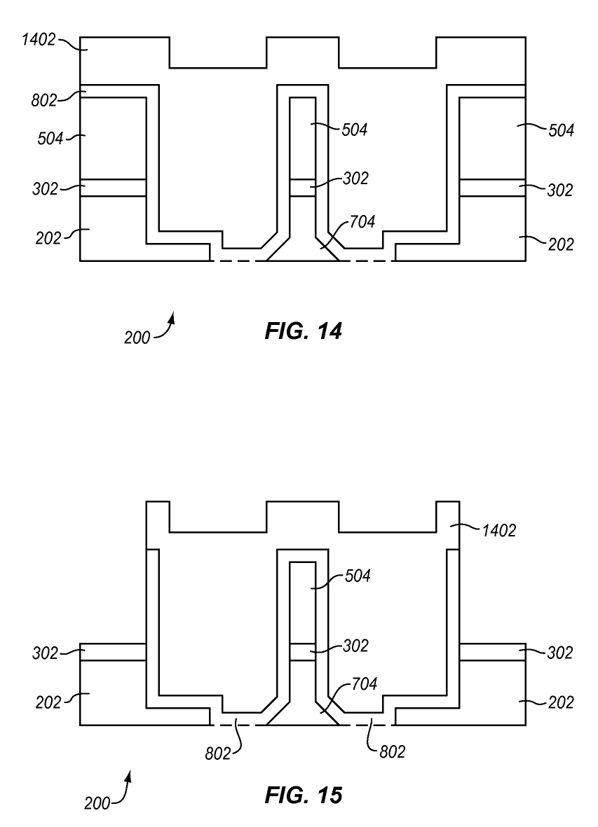

In step 1312, an insulating layer 802 is deposited on read sensor 704 (see FIG. 8). In step 1314 a hard bias layer 1402 is deposited on insulating layer 802 (see FIG. 14). Hard bias layer 1402 is deposited on side regions of read sensor 704 to a height above protective layer 302. A second protective layer (e.g., a DLC layer) therefore does not need to be deposited during the fabrication process. The portion of hard bias layer 1402 (i.e., overfill hard bias) above read sensor 704 may then be removed during the CMP process to achieve a flat gap surface. The resulting structure of magnetic sensor head 200 is illustrated in FIG. 14.

In step 1316, a lift-off process is performed to remove mask structure 504 in the field of magnetic sensor head 200 (see FIG. 15). In step 1318 of the present method, a CMP process is performed down to the stop layers. Any material above protective layer 302, such as a portion of insulating material 802 and a portion of hard bias layer 1402 is removed with mask structure 504.

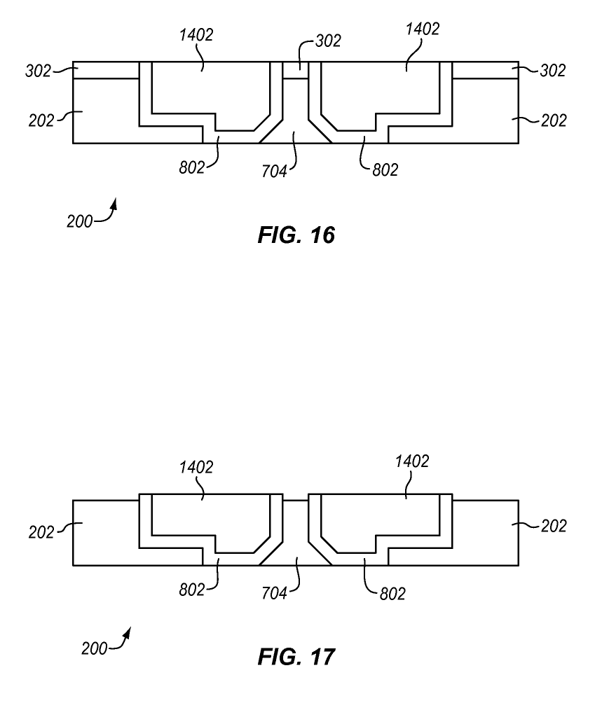

In step 1318 of method 1300, portions of hard bias layer 1402 (see FIG. 16) at a height above protective layer 302 are removed. Once the CMP process stops at protective layer 302, hard bias layer 1402 will be planarized, as exemplified in FIG. 16 to achieve a flat read gap.

In step 1320, remaining portions of protective layer 302 may be removed using an etching process. If carbon is used as protective layer 302, then a reactive ion etching (RIE) process may be utilized to remove the end regions of protective layer 302. The resulting structure of magnetic sensor head 200 is illustrated in FIG. 17. A second shield layer (not shown) may then be fabricated on the top of magnetic sensor head 200.

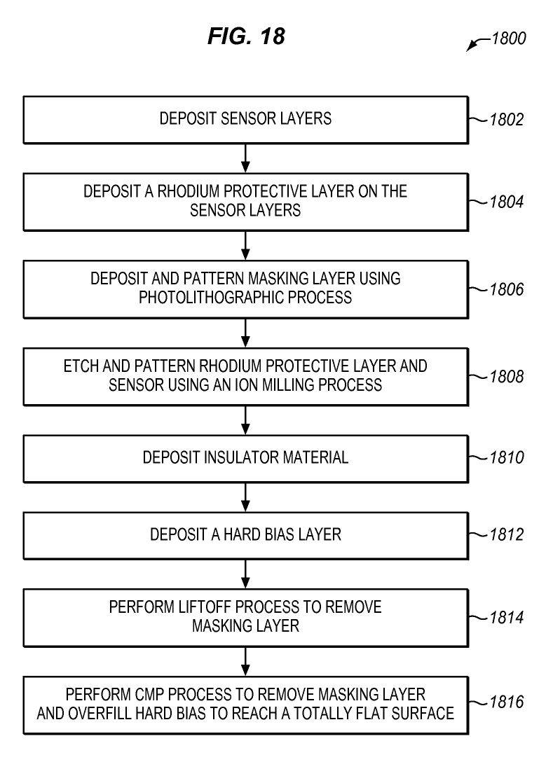

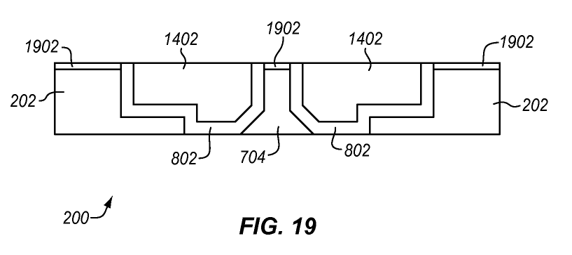

In another exemplary embodiment of the invention, protective layer 302 may comprise a conductive material, such as rhodium, which is not removed during an etching step. Rather, the rhodium remains as a sensor cap 1902 of read sensor 704 as illustrated in FIG. 19. FIG. 18 is a flow chart illustrating a method 1800 for fabricating magnetic sensor heads in an exemplary embodiment of the invention in which a conductive material is used for the protective layer. The steps of the flow chart in FIG. 18 are not all inclusive and may include other steps not shown.

In step 1802, sensor layers 204 (see FIG. 2) for a magnetic sensor head 200 are deposited on a shield layer (not shown). The sensor layers 204 may be surrounded by insulating material 202. Insulating material 202 may be any suitable dielectric material, such as alumina (Al₂O₃) or SiO₂. The sensor layers 204 and insulating material 202 may be deposited during a stripe height definition process defining the stripe height of a read sensor of magnetic sensor head 200 prior to defining the track width of the read sensor. The resulting structure of magnetic sensor head 200 is illustrated in FIG. 2.

In step 1804, a rhodium protective layer 302 (see FIG. 3) is deposited on sensor layers 204. Protective layer 302 acts as a stop layer during a later CMP process and forms part of a sensor cap of a read sensor of the magnetic sensor head 200. The resulting structure of magnetic sensor head 200 is illustrated in FIG. 3.

In step 1806, a masking layer 402 of FIG. 4 is deposited on protective layer 302. Masking layer 402 is etchable for definition of a mask structure 504 (see FIG. 5).

In step 1808, protective layer 302 and sensor layers 204 are etched around mask structure 504 to remove a portion of protective layer 302 in end regions of sensor layers 204 and define read sensor 704. If rhodium is used as protective layer 302, then an ion milling process may be utilized for the etching process. As shown by the resulting structure of magnetic sensor head 200 in FIG. 6, end regions of sensor layers 204 are thereby exposed as a result of the etching process in step 1808. Portions of insulating material 202 may also be removed. The resulting structure of magnetic sensor head 200 is illustrated in FIG. 7.

In step 1810, an insulating layer 802 is deposited on read sensor 704 (see FIG. 8). In step 1812, a hard bias layer 1402 is deposited on insulating layer 802 (see FIG. 14). Hard bias layer 1402 is deposited on side regions of read sensor 704 to a height above protective layer 302.

In step 1814, a lift-off process is performed to remove mask structure 504 in the field of magnetic sensor head 200 (see FIG. 15). In step 1316, a CMP process is performed down to protective layer 302 to remove mask structure 504 and overfill hard bias material 902 to reach a flat surface. The resulting structure of magnetic sensor head 200 is illustrated in FIG. 19. The portion of protective layer 302 above read sensor 704 remains as part of a sensor cap 1902 (see FIG. 19) of read sensor 704, and protective layer 302 may also serve as the top lead as well as adjusting the gap thickness to the targeted reader gap thickness and obtain a totally flat reader gap.

Although specific embodiments were described herein, the scope of the invention is not limited to those specific embodiments. The scope of the invention is defined by the following claims and any equivalents therein.

We claim:

1. A method for fabricating magnetic sensor heads with flat reader gaps, the method comprising:
defining a read sensor of a magnetic sensor head;
depositing an insulator layer on the read sensor;
depositing a hard bias layer on the insulator layer;
performing a chemical mechanical polishing (CMP) process down to a protective layer on the read sensor deposited while defining the read sensor to remove an overfill portion of the hard bias layer above the protective layer and to remove a sensor pattern masking structure above the protective layer.

2. The method of claim 1 wherein performing the CMP process further comprises:
polishing the hard bias layer to a target thickness of the hard bias layer; and
lifting off the sensor pattern masking structure above the protective layer.

3. The method of claim 1 wherein defining the read sensor further comprises:
depositing sensor layers;
depositing the protective layer on the sensor layers;
depositing a masking layer on the protective layer, wherein the masking layer is etchable for definition of the mask structure;
etching the protective layer around the mask structure to remove a portion of the protective layer; and
etching the sensor layers to define the read sensor.

4. The method of claim 1 further comprising etching the protective layer after the CMP process to remove a remaining portion of the protective layer.

5. The method of claim 1 wherein the protective layer comprises diamond like carbon (DLC).

6. The method of claim 5 wherein the DLC protective layer is etched after the CMP process through a reactive ion etching (RIE) process.

7. The method of claim 1 wherein the protective layer comprises rhodium (Rh).

8. The method of claim 7 wherein the rhodium forms part of a sensor cap for the read sensor.

9. The method of claim 1 further comprising:
performing a lift-off process to remove the mask structure on side regions of the read sensor.

10. The method of claim 1 wherein defining the read sensor defines a track width of the read sensor.

11. A method for fabricating magnetic sensor heads with flat reader gaps, the method comprising:
defining a track width of a read sensor of a magnetic sensor head;
depositing an insulator layer on the read sensor;
depositing a hard bias layer on the insulator layer;
performing a lift-off process to remove a mask structure deposited while defining the read sensor, wherein the mask structure is removed on side regions of the read sensor; and
performing a chemical mechanical polishing (CMP) process down to a protective layer on the read sensor deposited while defining the read sensor to remove an overfill portion of the hard bias layer above the protective layer and to remove the mask structure above the protective layer.

12. The method of claim 11 wherein the protective layer comprises rhodium.

13. The method of claim 12 wherein the rhodium forms part of a sensor cap for the read sensor.

14. A method for fabricating magnetic sensor heads with flat reader gaps, the method comprising:
depositing sensor layers;
depositing a protective layer on the sensor layers;
depositing a masking layer on the protective layer, wherein the masking layer is etchable for definition of a mask structure;
etching the protective layer around the mask structure to remove a portion of the protective layer;
etching the sensor layers to define a read sensor;
depositing an insulator layer on the read sensor;
depositing a hard bias layer on the insulator layer; and
performing a chemical mechanical polishing (CMP) process down to the protective layer to remove an overfill portion of the hard bias layer above the protective layer and to remove the mask structure above the protective layer.

15. The method of claim 14 further comprising etching the protective layer after the CMP process to remove a remaining portion of the protective layer.

16. The method of claim 14 wherein the protective layer comprises diamond like carbon (DLC), and the DLC is etched after the CMP process through a reactive ion etching (RIE) process.

17. The method of claim 14 wherein the protective layer comprises rhodium.

18. The method of claim 17 wherein the rhodium forms part of a sensor cap for the read sensor.

19. The method of claim 14 further comprising:
performing a lift-off process to remove the mask structure on side regions of the read sensor.

20. The method of claim 14 wherein etching the sensor layers defines a track width of the read sensor.
